(19) United States
(12) Patent Application Publication
(10) Pub. No.: US 2026/0367209 A1
(43) Pub. Date: Nov. 19, 2026

(54) INDOOR LOCATION SYSTEM

(71) Applicant: British Telecommunications Public Limited Company, London (GB)

(72) Inventors: Richard WISEMAN, London (GB); Ian THURLOW, London (GB); Stephen MCCONNELL, London (GB); Jack JOHNS, London (GB); Evandro PIOLI MORO, London (GB); Sandra STINCIC CLARKE, London (GB)

(21) Appl. No.: 19/135,498

(22) PCT Filed: Nov. 15, 2023
(86) PCT No.: PCT/EP2023/081846

§ 371 Date: Jun. 4, 2025

(30) Foreign Application Priority Data
Dec. 9, 2022 (EP) 22212541.1
Dec. 9, 2022 (GB) 2218554.0

(51) Int. Cl. G01S 3/04; G01S 3/02; G01S 3/14; G01S 5/02

(52) U.S. Cl. CPC G01S 3/043; G01S 3/023; G01S 3/14; G01S 5/0273; G01S 2205/02

(57) ABSTRACT

The present disclosure relates to methods and related systems for locating a device in an indoor environment. In particular, this disclosure relates to using one or more reconfigurable intelligent surfaces (RISs) and at least one receiver to locate a device in an indoor environment, based on a peak strength of its signal.

### PRIORITY CLAIM

The present application is a National Phase entry of PCT Application No. PCT/EP2023/081846, filed Nov. 15, 2023, which claims priority from EP Application Serial No. 22212541.1 filed Dec. 9, 2022, and GB Application No. 2218554.0, filed Dec. 9, 2022, each of which hereby fully incorporated herein by reference.

### TECHNICAL FIELD

The present disclosure relates to methods and systems for locating a device in an indoor environment. In particular, it relates to using one or more reconfigurable intelligent surfaces (RISs) and at least one receiver to locate a device in an indoor environment, based on a peak strength of a signal emitted by the device and reflected by the RIS.

### BACKGROUND

A reconfigurable intelligent surface (RIS) is a two-dimensional surface having discrete elements, where the impedance of each element can be modified to control the interaction between the RIS and electromagnetic signals incident on the surface of the RIS. For example, each element of an RIS can be configured electronically (and hence programmatically) to control the reflection or refraction of an incident electromagnetic signal. RISs are easy to deploy and are energy efficient as they do not amplify the signals that they reflect.

An RIS is typically used to provide alternative paths to circumvent an obstruction between, for example, a device and a transmitter. In this way, the RIS enables the signal to/from a device in a known location/direction to be maximized.

Recently there has been research on implementing an RIS in an indoor environment [1]-[4] to create a smart radio environment. In particular, there has been research on using an RIS to locate a device in an indoor environment, where it is difficult to rely on GPS signals. Localization issues may also arise where the device is a constrained device—that is, a constrained device, due to size and power requirements, may not have integrated location/tracking/processing capabilities. Elzanty et al. [3], describe an algorithm where the RIS phases are designed to maximize the signal-to-noise ratio towards a desired device for localization enhancement. Albanese et al. [4] describe another algorithm which relies on prior statistical information on a device for estimating the location of the device by performing statistical beamforming, time-of-arrival and direction-of-arrival estimation.

Despite the research into using RIS-assisted systems for localization of a device, the related prior art methods are complex, time-consuming and in some cases, require prior information relating to the device position to provide an estimate of the location of the device. There is a need therefore, for a simple and efficient method and system for locating a device in an indoor environment.

### SUMMARY OF DISCLOSURE

Embodiments of the present disclosure relate to providing simpler and efficient methods and systems for using one or more RISs and at least one receiver to locate a device in an indoor environment, based on the peak strength of a signal emitted by the device and reflected by the RIS.

The inventors have recognized the need to provide a simple and efficient RIS-assisted system to estimate a location of a device in an indoor environment. In the present disclosure, the RIS scans, in one embodiment across its entire angular range, for a signal emitted by a device which to be located. The RIS reflects any signal present at each angle (and hence each direction) thereby allowing a receiver to monitor for a signal emitted by the device in each scanned direction. The receiver could be co-located with the RIS or even built into it. Knowledge of the peak signal strength and the associated scanned angle between the RIS and the device, enables a direction of the device to be approximated thereby enabling the device to be located.

In the context of this application, locating a device is defined as determining an approximate direction of the device. The present method for locating the device may be further improved to provide positional information on the device and/or to identify the device. For example, positional information may be obtained by triangulating the determined direction information with similar information from other RISs in the indoor environment. This example will be detailed later in the description with respect to FIG. 4. In another example, the determined direction information may be combined with known information about the device (e.g., model and/or battery level) to identify the device. For example, the RIS-assisted system may optionally record parameters such as unique device identifiers, battery level and/or variance of connectivity strength and use this data together with the determined direction information to identify the device. The method of the present disclosure can also be extended to simultaneously calculate the locations of multiple devices as will be described later in this description with reference to table 1.

As an RIS does not typically “transmit” or “receive” a signal, being a passive (albeit configurable) reflector, for the purposes of this application, the term “RIS” means a standalone passive RIS (that is, one that does not transmit/receive signals). The term “RIS-transmitter” can either mean a standalone RIS that can also act as a signal transmitter, or the combination of a standalone passive RIS and a separate transmitter linked to and coordinating with the RIS. Similarly, the term “RIS-receiver” can either mean a standalone RIS that can also act as a signal receiver, or the combination of a standalone passive RIS and a separate receiver linked to and coordinating with the RIS.

An indoor environment, for the purposes of this application, refers to an environment where GPS signals are restricted or are variable in accuracy, for example, inside a building.

The term signal strength, for purposes of this application, refers to the power of a signal. The term “peak” refers to a maximum value of the power of a signal over successive scans by the RIS or it may refer to one or more value(s) of the power of the signal above a predefined threshold. The detected peak(s) may be in a single wireless band or multiple bands may be measured separately or collectively to define where the peaks are located.

According to a first aspect of the disclosure, a method is provided for locating a device in an indoor environment having at least one reconfigurable intelligent surface (RIS), the method comprising: scanning, by the at least one RIS, for a signal emitted by the device by varying a scan angle with successive iterations; reflecting, by the at least one RIS, a signal associated with each scan angle onto at least one receiver, the at least one receiver being located in a known relative position with respect to the RIS; monitoring, by the at least one receiver, a signal strength associated with the reflected signal for each scan angle; determining a peak signal strength based on the said monitoring of signal strengths over successive iterations; and locating the device by determining a direction of the signal emitted by the device based on the peak signal strength and the related scan angle.

According to a second aspect of the disclosure, a method is provided for locating a device in an indoor environment having a plurality of reconfigurable intelligent surfaces (RISs), the method comprising: scanning, by each of the plurality of RISs, for a signal emitted by the device by varying a scan angle of each of the plurality of RISs with successive iterations; reflecting, by each of the plurality of RISs, a signal associated with each scan angle onto a corresponding receiver, wherein each corresponding receiver is located in a known relative position with respect to the RIS; monitoring, by each corresponding receiver, a signal strength associated with the reflected signal for each scan angle of each of the plurality of RISs; determining a peak signal strength based on the said monitoring of signal strengths over successive iterations by each corresponding receiver; and locating the device by correlating the peak signal strengths and using triangulation to determine a position of the device.

According to a third aspect of this disclosure, a system is provided for locating a device in an indoor environment, the system comprising: at least one RIS located in the indoor environment; at least one receiver located in a known relative position with respect to the RIS in the indoor environment; a processor; and a computer-readable medium having stored thereon computer executable instructions that when executed cause the processor to: enable the at least one RIS to scan for a signal emitted by the device by vary a scan angle in successive iterations; enable the at least one RIS to reflect a signal associated with each scan angle onto the receiver; enable the receiver to monitor for a signal strength associated with the reflected signal for each scan angle; determine a peak signal strength based on the said monitoring of signal strengths over successive iterations; and locate the device by determining a direction of the signal emitted by the device based on the peak signal strength and the related scan angle.

According to further aspect of the disclosure a system is provided for locating a device in an indoor environment, the system comprising: a plurality of RISs located in the indoor environment; a corresponding receiver for each of the plurality of RISs, wherein each corresponding receiver is located in a known relative position with respect to the RISs in the indoor environment; a processor; and a computer-readable medium having stored thereon computer executable instructions that when executed cause the processor to: enable each of the plurality of RISs to scan for a signal emitted by the device by varying a scan angle of each of the plurality of RISs with successive iterations; enable each of the plurality of RISs to reflect a signal associated with each scan angle onto a corresponding receiver; enable each corresponding receiver to monitor a signal strength associated with the reflected signal for each scan angle of each of the plurality of RISs; determine a respective peak signal strength based on the said monitoring of signal strengths over successive iterations by each corresponding receiver; and locate the device by correlating the peak signal strengths and using triangulation to determine a position of the device.

### BRIEF DESCRIPTION OF THE DRAWINGS

The teachings of this disclosure will be discussed, by way of non-limiting examples, with reference to the accompanying drawings, in which:

FIG. 1 shows an example RIS-assisted system for locating a device according to an embodiment of this disclosure.

FIG. 2 shows a birds-eye view of the RIS-assisted system of FIG. 1 implementing a method according to an embodiment of this disclosure to locate a device.

FIG. 3 is a flow chart of a method, according to an embodiment of this disclosure, for locating a device in an indoor environment having at least one reconfigurable intelligent surface (RIS).

FIG. 4 is a flow chart of another method, according to an embodiment of this disclosure, for locating a device in an indoor environment having a plurality of reconfigurable intelligent surfaces (RISs).

### DETAILED DESCRIPTION

A reconfigurable intelligent surface (RIS) is a two-dimensional surface having discrete elements, where the impedance of each element can be modified to control the interaction between the RIS and electromagnetic signals incident on the surface of the RIS. For example, each element of an RIS can be configured electronically (and hence programmatically) to control the reflection or refraction of an incident electromagnetic signal. RISs are easy to deploy and are energy efficient as they do not amplify the signals that they reflect.

The inventors have recognized the need to provide a simple and efficient RIS-assisted system to estimate a location of a device in an indoor environment.

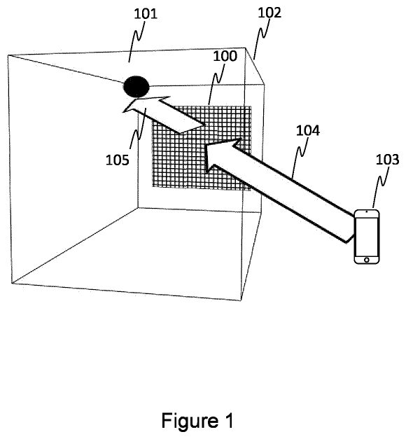

FIG. 1 shows an example RIS-assisted system for locating a device according to an embodiment of this disclosure. In FIG. 1, the RIS 100 is located within a room 102, a signal 104 from the device 103 is incident on the RIS and reflected 105 by the RIS 100 onto a receiver 101, opposite (for example, in the line of sight of) the RIS, which monitors the reflected signal 105, for example, by detecting its signal strength. The device 103, while still being located in an indoor environment (for example, within a building) can be inside or outside the room having the RIS. In FIG. 1, the device 103 is shown as being located outside the room having the RIS. While in FIG. 1, the receiver 101 is shown to be co-located with the RIS 100, in other examples, the receiver 101 may also be built into the RIS 100.

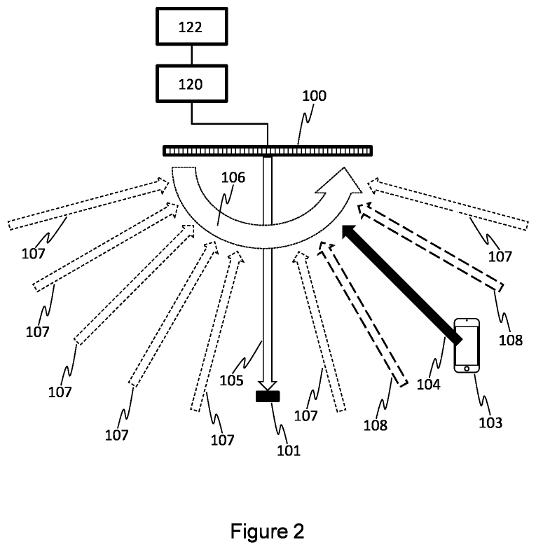

FIG. 2 is a bird's-eye view of the example RIS-assisted system of FIG. 1. In FIG. 2, the RIS 100 is a vertical plane viewed from the top and only a single horizontal plane is shown for the scan range 106. FIG. 2 shows a scanning strategy implemented using the RIS 100 to estimate a peak signal strength of a signal 104 emitted by a device 103. In this example, the scan is performed across the entire angular range 106 of the RIS. At each scan angle 107, a signal strength reading is taken at receiver 101 (on which reflected signal 105 is incident). Negligible signal strength is detected for most of the scan angles 107 and a relatively increased signal strength is detected at two scan angles, 108 compared to the other scan angles 107. Based on the detected maximum signal strength and the related scan angle, the RIS-assisted system in FIG. 1, determines an approximate direction of the device 103, thereby locating the device.

Also shown in FIG. 2 is a processor 120 associated with the RIS 100, and having one or more computer readable storage media 122 accessible thereby, that stores instructions to cause the processor 120 to operate the RIS and provide any processing necessary to perform the methods described below. The processor 120 and storage medium 122 may be integrated with the RIS, or separate therefrom but in communication with the RIS

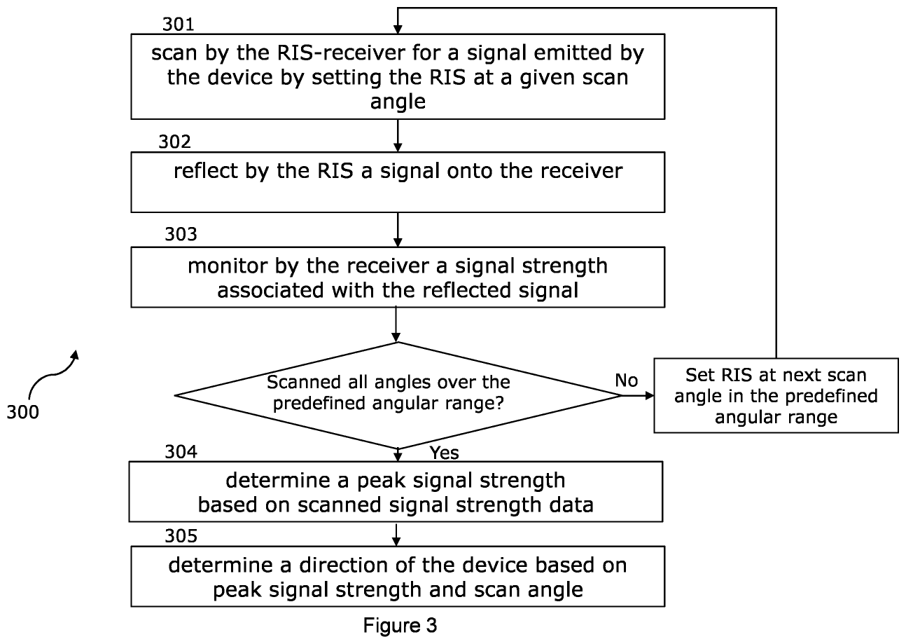

FIG. 3 shows a flow chart of the method described in FIG. 2 to locate a device 103 by determining a direction of the device 103, according to an embodiment of this disclosure. That is, FIG. 3 shows a method 300 for locating a device 103 in an indoor environment having at least one reconfigurable intelligent surface, RIS 100. The method comprises, at 301, the RIS-receiver (100,101) scans for a signal emitted by the device by setting the RIS 100 at a first scan angle in a given angular range (which may be the entire angular range of the RIS 100 or a subset of this angular range). For each scan angle, the RIS 100 reflects a signal (if any present) onto at least one receiver 101 (302). In 303, the receiver 101 monitors a signal strength associated with the reflected signal for each scan angle. In the absence of any signal or if only a weak signal is present, the signal strength reading at the receiver 101 is recorded as zero or negligible, respectively. Operations 301-303 are performed iteratively across the predefined scan angles in a given angular range. The signal strength data, as monitored or recorded by the receiver over the different scan angles, (that is, over successive iterations) is then processed, either at the receiver or a separate processor, to determine a peak signal strength (304). The device 103 is then located by determining a direction of the signal emitted by the device based on the peak signal strength and the related scan angle (305).

The method 300 for locating the device may be further improved to provide positional information on the device and/or to identify the device. In one example, the determined direction information may be combined with known information about the device (e.g., model and/or battery level) to identify the device. For example, the RIS-assisted system may optionally record parameters, for example, from cooperating devices, where the recorded parameters may include unique device identifiers, battery level and/or variance of connectivity strength and use this data together with the determined direction information to identify the device. In another example, knowledge of the device model (if known—for example, via an initial handshake or the MAC address prefix), may be used to estimate a distance of the device 103 from the RIS 100 based upon the detected signal strength at 108 and the RIS's 100 knowledge of the indoor environment (which could be explicitly defined or could be derived from other interactions such as previous executions of the scanning process, or a combination of both).

In another embodiment, the described scanning in the method 300, could be modified dynamically to locate a device more quickly. For example, the scanning may comprise varying the scan angle by a first predetermined amount with successive iterations across a first angular range to provide a coarse estimate of the direction of the device 103. This can be followed by a further scan where the scan angle is varied by a second predetermined amount across a second angular range about the first estimate, wherein the second predetermined amount is less than the first predetermined amount and the second angular range is a subset of the first angular range, so as to provide a finer scan and a more precise estimate of the direction of the device 103. In another embodiment, the scan angle in the further scan may be varied dynamically, for example depending on the number of devices, occupancy in the room etc. with the second angular range being a subset of the first angular range.

In some embodiments, the RIS may receive an initial estimate of the device's location and the scan may be performed within a predefined angular range around this estimate, where the predefined angular range is a subset of the entire angular range of the RIS. For example, where the device has GPS capability built-in, this can be used to provide an initial reading for the location of the device. However, as GPS accuracy is variable in an indoor environment, such a reading should generally only be taken as an initial estimate. If the device and the RIS are coordinating to establish the device's indoor location, then this initial estimate of the location of the device would be passed on to the RIS. Where the device is a cellular device, cellular triangulation from multiple cellular masts can also be used to provide an initial estimate for a location of the device. Similarly, a device's accelerometer, gyroscope, and compass provide enough information to gauge a direction and a speed of travel of the device. Thus, once a location of the device is determined with acceptable accuracy, its location can be continually updated (estimated) based upon measurements from the accelerometer, gyroscope, and compass, though the reliability of the location estimate may deteriorate with time.

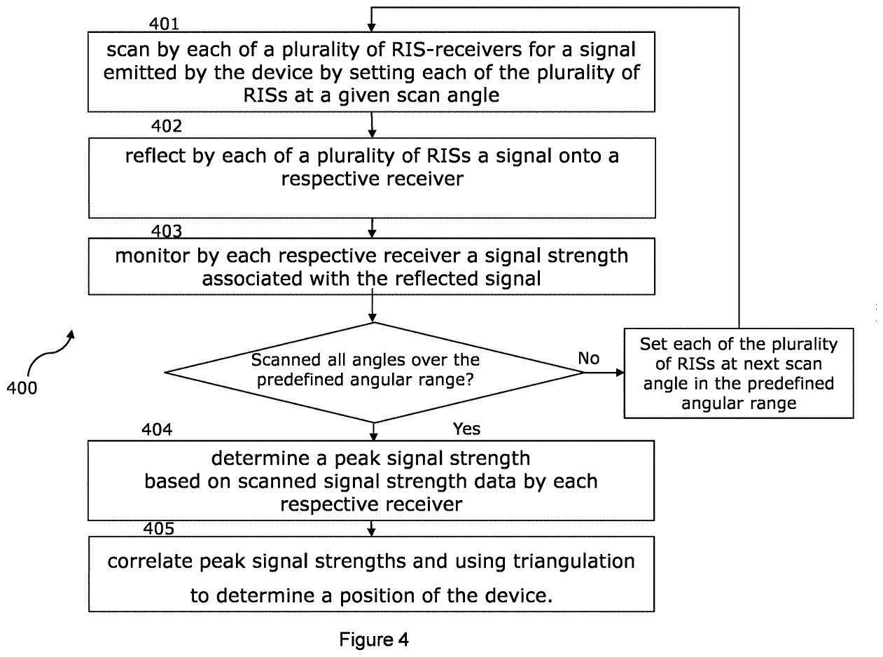

The system as shown in FIG. 1 and FIG. 2 may be extended to include a plurality of RISs which co-ordinate with each other, via wired or wireless connection, to locate the device. The system comprises one or more receivers operating together with the plurality of RISs to locate the device. In one example, the system comprises a dedicated receiver for each of the plurality of RISs to monitor a peak signal strength—this is described in more detail in the related method of FIG. 4 below. This configuration would improve the location estimate as multi-point triangulation can be used to provide positional information on the device. That is, the use of multiple RISs enables the location of the device to be determined by triangulation thereby providing an approximate position of the device (as opposed to an estimate of the direction of the device) and advantageously does not require the RIS-assisted system to have any prior knowledge about the device for determining this location.

FIG. 4 shows a method 400 for locating a device 103 in an indoor environment having a plurality of RISs, according to another embodiment of this disclosure. The method of FIG. 4 is similar to that shown in FIG. 3 in that the scanning and reflecting as described in FIG. 3, are performed by each of the plurality of RISs in the method of FIG. 4 and the monitoring of the signal strength is performed by a respective receiver for each of the plurality of RISs. For the sake of completeness, we will now describe the method of FIG. 4 in detail.

In the method 400, at 401, each of the plurality of RIS-receivers scans for a signal emitted by the device 103 by varying a scan angle of each of the plurality of RISs across a predefined angular range. At 402, each of the plurality of RISs reflects a signal associated with each scan angle onto a corresponding receiver, wherein each corresponding receiver is located in a predetermined position (that is, the receiver may be co-located with the respective RIS or integrated into the respective RIS). At 403, each respective receiver monitors a signal strength associated with the reflected signal for each scan angle of each of the plurality of RISs. Similar to method 300, 401-403 are performed iteratively across the predefined scan angles in a given angular range. At 404, each corresponding receiver determines a peak signal strength based on the said monitoring of signal strengths over successive iterations by each receiver. At 405 the device is located by correlating the peak signal strengths and using triangulation to determine a position of the device. In the described method, the plurality of RISs are configured to coordinate with each other so as to ensure that each of the receivers detect only the signal reflected by their respective RIS.

As described earlier with respect to the method of FIG. 3, the scanning by each of the plurality of RISs in the method of FIG. 4, can also be modified dynamically to locate a device more quickly. For example, the scanning may comprise varying the scan angle by a first predetermined amount with successive iterations across a first angular range to provide a coarse estimate of the direction of the device 103. This can be followed by a further scan where the scan angle is varied by a second predetermined amount across a second angular range about the first estimate, wherein the second predetermined amount is less than the first predetermined amount and the second angular range is a subset of the first angular range, so as to provide a finer scan and a more precise estimate of the direction of the device 103.

Similar to the options described earlier with respect to the method in FIG. 3, an initial estimate of a device location may be provided to one or more of the RISs for improving a location measurement RISs. In another example, where location of a previous device or devices are known for similar/comparable peak signal strengths, especially in a system where multiple RISs are coordinating, this data can be used to provide a reliable initial estimate of a device's location, especially where the previous device or devices are comparable (e.g., same model, range, or chipset) to the device in question. In another example, blockchain techniques may be used to provide an auditable record of a device's calculated/perceived location. For example, based on previous recorded locations and timings of the device as held in a blockchain, a prediction of the device's next location(s) could be used to vary the scan angle in the described method. In a further example, similar to the example relating to the provision of known locations of a previous device or devices, the RIS-assisted system may comprise a number of known devices scattered, randomly or strategically, throughout an area of interest (typically a building, floor, or large indoor area). In this case, each known device must know its precise location (because it is static) and is configured to provide this information along with various other device-related information, in particular signal strength readings, to the one or more RISs. An RIS-assisted system according to the present disclosure can use the known locations of the known devices scattered in the indoor environment as reference data to improve the accuracy of an unknown device's location determined by a method of the present disclosure. This example can be further modified to have, for example, one or more known mobile devices which move around an area of interest (such a building or room in an indoor environment), where the mobile devices are able to keep track of their precise location while moving, for example, through visual analytics of their surroundings, or using QR codes on a floor or ceiling. The information relating to a known but changing location may then be provided to the one or more RIS(s) along with the previously-mentioned signal strength readings and other information to improve the accuracy of a location of a device determined according to a method of the present disclosure.

In another example, a location measurement of a device determined by a method of the present disclosure can be further improved by using a beacon device emitting beacon signals or beacons to enable the device and/or RIS to estimate a distance of separation between the RIS and the device based on the time taken for the electromagnetic pulses or beacons to arrive at the device. For example, a direction of the device is first determined using a method of the present disclosure. Then, a beacon device periodically emits beacon pulses which are reflected by the RIS and received by the device. The distance between the beacon device and the RIS is predetermined. The beacons are generic pulses that are sent within a reasonable timeframe to avoid interference with the reflected signals. These beacons are received by the target device and an estimate of the travel time for the beacons, from the RIS to the device, is determined using any known mathematical signal processing method. This in turn enables a distance between the RIS and the device to be estimated. This method works best if there are multiple RISs. Where there is only one RIS, repeated measurements from the said RIS still enable a location estimate of the device to be calculated.

Table 1 below shows an example of normalized signal strength data obtained using, for example method 300 in FIG. 3 or method 400 in FIG. 4, of the present disclosure. It is noted here that the data in table 1 is fictional and only used for illustrative purposes to explain how peak signal strengths are determined over scanned angles. In Table 1, measurements of normalized signal strengths are provided for a given horizontal or vertical scan angle, shown in columns and rows respectively, and values are normalized so that the highest (or peak) signal strength is 100%. Normalization may be linear or logarithmic, for example, depending upon requirements.

TABLE 1
Example of normalized signal strength measurement data obtained
using, for example method 300, of the present disclosure

| | −180 | −150 | −120 | −90 | −60 | −30 | 0 | 30 | 60 | 90 | 120 | 150 | 180 |
|---|---|---|---|---|---|---|---|---|---|---|---|---|---|
| −180 | 0 | 0 | 0 | 0 | 0 | 0 | 0 | 0 | 0 | 0 | 0 | 7 | 20 |
| −150 | 0 | 0 | 40 | 45 | 30 | 0 | 0 | 0 | 0 | 0 | 0 | 4 | 8 |
| −120 | 0 | 0 | 45 | 50 | 40 | 0 | 0 | 0 | 0 | 0 | 0 | 0 | 0 |
| −90 | 0 | 0 | 35 | 40 | 30 | 0 | 0 | 0 | 0 | 0 | 0 | 0 | 0 |
| −60 | 0 | 0 | 0 | 0 | 0 | 0 | 0 | 0 | 20 | 30 | 20 | 0 | 0 |
| −30 | 0 | 0 | 0 | 0 | 5 | 0 | 0 | 0 | 30 | 100 | 30 | 0 | 0 |
| 0 | 0 | 0 | 0 | 4 | 30 | 5 | 0 | 0 | 20 | 30 | 20 | 0 | 0 |
| 30 | 0 | 0 | 0 | 0 | 5 | 0 | 0 | 0 | 0 | 0 | 0 | 0 | 0 |
| 60 | 0 | 0 | 0 | 0 | 0 | 0 | 0 | 0 | 0 | 0 | 0 | 0 | 0 |
| 90 | 30 | 40 | 30 | 0 | 0 | 0 | 0 | 0 | 0 | 0 | 0 | 0 | 0 |
| 120 | 40 | 80 | 40 | 0 | 10 | 0 | 0 | 20 | 0 | 0 | 0 | 0 | 0 |
| 150 | 30 | 40 | 30 | 0 | 0 | 0 | 0 | 0 | 0 | 0 | 0 | 0 | 0 |
| 180 | 0 | 0 | 0 | 0 | 0 | 0 | 0 | 0 | 0 | 0 | 0 | 0 | 0 |

As seen in Table 1, there are two significant peaks in signal strength: a first value at about −150° horizontally and 120° vertically; a second value at about 90° horizontally and −30° vertically. There are also other smaller peaks such as a peak at −90° horizontally, −120° vertically and another smaller peak at −60°, 0°, etc.

These values of signal strength likely indicate the approximate directions of three or more devices, though it is possible that more than one device could be aligned in a single linear direction, so one or more of these peaks could indicate multiple devices. However, if signal correlation is being performed using known techniques in the art to allow coordination between multiple RISs, as in method 400 of FIG. 4, then individual devices can be distinguished even if they are in the same direction.

The device in the described systems of the present disclosure, may be any type of device emitting an electromagnetic signal—for example, the device may be a cellular device such a mobile phone or a wearable device. A wearable device is an electronic device worn on the human body, such as a tracking unit used to monitor vital health signals such as heart rate. Wearable devices tend to be IoT (Internet of Things) devices as they are internet-connected. Some wearable devices may have location/tracking capabilities, but given their size and power requirements, many do not. Therefore, a method according to the present disclosure, can be advantageously used to locate such a constrained device in an indoor environment, in a simple and efficient manner.

The determination of the peak signal strength and a direction of the device based on scanned data, as described with respect to FIGS. 1-4, can be performed by any suitable means, for example, by using microcontrollers, programmable logic arrays or even as software that executes on one or more processors to perform the said determination. The said means may be integrated within the receiver such that the receiver performs both the monitoring and determination of the peak signal strength and the direction of the device.

Whilst the disclosure is particularly useful for locating a device in an indoor environment, it is not limited to this application and may be equally useful for any application which implements an RIS in an outdoor (or any) environment in which RISs can be deployed.

### REFERENCES

[1] E. Bjornson, H. Wymeersch, B. Matthiesen, P. Popovski, L. Sanguinetti, and E. de Carvalho, “Reconfigurable Intelligent Surfaces: A Signal Processing Perspective With Wireless Applications.” DOI: 10.1109/MSP.2021.3130549
[2] H. Wymeersch, J. He, B. Denis, A. Clemente and M. Juntti, “Radio Localization and Mapping With Reconfigurable Intelligent Surfaces: Challenges, Opportunities, and Research Directions,” DOI: 10.1109/MVT.2020.3023682.
[3] A. Elzanaty, A. Guerra, F. Guidi, M. Alouini, “Reconfigurable Intelligent Surfaces for Localization: Position and Orientation Error Bounds”, DOI: 10.48550/ARXIV.2009.02818
[4] A. Albanese, P. Mursia, V. Sciancalepore, X. Costa-Perez, “PAPIR: Practical RIS-aided Localization via Statistical User Information”, DOI: 10.48550/arXiv.2109.08532

1. A method for locating a device in an environment having at least one reconfigurable intelligent surface (RIS) and at least one receiver which together form at least one RIS-receiver, the method comprising:
scanning, by the at least one RIS-receiver, for a signal emitted by the device by varying a scan angle of the at least one RIS with successive iterations;
reflecting, by the at least one RIS, a signal associated with each scan angle onto the at least one receiver, the at least one receiver being located in a known relative position in the environment with respect to the at least one RIS;
monitoring, by the at least one receiver, a signal strength associated with the reflected signal for each scan angle;
determining a peak signal strength based on the monitoring of the signal strengths over successive iterations; and
locating the device by determining a direction of the signal emitted by the device based on the peak signal strength and the related scan angle.

2. The method according to claim 1, wherein the at least one receiver is co-located with the at least one RIS.

3. The method according to claim 1, wherein the at least one receiver is integrated into the at least one RIS.

4. The method according to claim 1, wherein the at least one receiver is in the line of sight of the at least one RIS.

5. The method according to claim 1, wherein the method further comprises varying the scan angle by a first predetermined amount with successive iterations across a first angular range.

6. The method according to claim 5, wherein the method further comprises varying the scan angle by a second predetermined amount with successive iterations across a second angular range, wherein at least one of: the second predetermined amount is less than the first predetermined amount, or the second angular range is a subset of the first angular range.

7. The method according to claim 1, wherein the device provides a first estimate of a location of the device to the RIS.

8. The method according to claim 1, wherein the device is a cellular device and wherein cell tower triangulation is used to provide a first estimate of a location of the device to the RIS.

9. The method according to claim 1, wherein the method further comprises providing the at least one RIS with device information to enable the identification of the device upon locating the device.

10. The method according to claim 9, wherein the device information comprises a battery level of the device.

11. The method according to claim 9, wherein the device information comprises information relating to a configuration of the device.

12. A method for locating a device in an environment having a plurality of reconfigurable intelligent surfaces (RISs) and respective receivers forming a plurality of RIS-receivers, the method comprising:
scanning, by each of the plurality of RIS-receivers, for a signal emitted by the device by varying a scan angle of each of the plurality of RISs with successive iterations;
reflecting, by each of the plurality of RISs, a signal associated with each scan angle onto a corresponding respective receiver, wherein each corresponding respective receiver is located in a known relative position with respect to the RISs;
monitoring, by each corresponding respective receiver, a signal strength associated with the reflected signal for each scan angle of each of the plurality of RISs;
determining a peak signal strength based on the said monitoring of signal strengths over successive iterations by each corresponding respective receiver; and
locating the device by correlating the peak signal strengths and using triangulation to determine a position of the device.

13. The method according to claim 1, wherein the scan angle is varied dynamically depending on the environment.

14. A system for locating a device in an environment, the system comprising:
at least one reconfigurable intelligent surface (RIS) located in the environment;
at least one receiver located in a known relative position with respect to the at least one RIS in the environment;
a processor; and
a computer-readable medium having stored thereon computer executable instructions that when executed cause the processor to:
enable the at least one RIS to scan for a signal emitted by the device by vary a scan angle in successive iterations;
enable the at least one RIS to reflect a signal associated with each scan angle onto the at least one receiver;
enable the receiver to monitor for a signal strength associated with the reflected signal for each scan angle;
determine a peak signal strength based on the said monitoring of signal strengths over successive iterations; and
locate the device by determining a direction of the signal emitted by the device based on the peak signal strength and the related scan angle.

15. A system for locating a device in an environment, the system comprising:
a plurality of reconfigurable intelligent surface (RISs) and corresponding receivers forming RIS-receivers, located in the environment, wherein each corresponding receiver is located in a known relative position with respect to the RISs in the environment;
a processor; and
a computer-readable medium having stored thereon computer executable instructions that when executed cause the processor to:
enable each of the plurality of RIS-receivers to scan for a signal emitted by the device by varying a scan angle of each of the plurality of RISs with successive iterations;
enable each of the plurality of RISs to reflect a signal associated with each scan angle onto a corresponding receiver, wherein each corresponding receiver is located in a predetermined position;
enable each corresponding receiver to monitor a signal strength associated with the reflected signal for each scan angle of each of the plurality of RISs;
determine a respective peak signal strength based on the said monitoring of signal strengths over successive iterations by each corresponding receiver;
locate the device by correlating the peak signal strengths and using triangulation to determine a position of the device.
